(19) United States
(12) Patent Application Publication
(10) Pub. No.: US 2007/0224570 A1
(43) Pub. Date: Sep. 27, 2007

(54) DENTAL ILLUMINATION DEVICE WITH SINGLE OR MULTIPLE TOTAL INTERNAL REFLECTORS (TIR)

(75) Inventors: John West, Arroyo Grande, CA (US); Scott Ganaja, San Luis Obispo, CA (US)

Correspondence Address: CROWELL & MORING LLP;INTELLECTUAL PROPERTY GROUP, P.O. BOX 14300, WASHINGTON, DC, 20044-4300, US

(73) Assignee: Den-Mat Corporation

(21) Appl. No.: 11/753,033

(22) Filed: May 24, 2007

Related U.S. Application Data
(63) Continuation of application No. 11/016,750, filed on Dec. 21, 2004, now abandoned.

(51) Int. Cl. A61C 3/00; A61C 19/00; A61C 5/00

(52) U.S. Cl. 433/29; 433/215; 433/25

(57) ABSTRACT

The present invention relates generally to a device that attaches to one or more Light Emitting Diode (LED) light source(s) to transmit and distribute light energy simultaneously across the arches of upper and lower teeth for dental tooth whitening and photo initiation of light curing resins while at the same time retaining the benefits of the light source(s) to be used for individual tooth whitening and curing.

### REFERENCE TO RELATED APPLICATION

This application is a continuation of U.S. patent application Ser. No. 11/016,750 filed Dec. 21, 2004, and claims the benefit of International patent application Ser. No. PCT/US05/46271 filed Dec. 21, 2005, both of which are hereby incorporated by reference in their entireties.

### FIELD OF THE INVENTION

The present invention relates generally to a device that attaches to one or more Light Emitting Diode (LED) light source(s) to transmit and distribute light energy simultaneously across the arches of upper and lower teeth for dental tooth whitening and photo initiation of light curing resins while at the same time retaining the benefits of the light source to be used for individual tooth whitening and curing.

### BACKGROUND OF THE INVENTION

As the world population increases and dental hygiene becomes more important, there are and will be a substantial increase in the number of patient visits to the dentist office. The needs from one patient to another may vary from teeth cleaning to taking x-rays, from filling cavities to whitening teeth. With an increasing number of visits to the dentist office, dentists face a daunting task of not only increasing their patient loads, but also providing a more effective and efficient patient care.

There have been many advances in dentistry over the years which have improved patient care. One of the advances includes the incorporation of photoinitiators into adhesive compositions useful for dental restoration. The light-initiated curing of a polymerizable matrix material involves photosensitization of light-sensitive compounds by ultraviolet or visible light, which, in turn, initiates polymerization of the matrix material. The photoinitiators are well known, and include by way of example, the combination of a photosensitive ketone (an acceptor in exciplexes) and a tertiary amine (a donor in exciplexes). Typical photosensitive ketones include benzophenone, acetophenone, thioxanthen-9-one, 9-fluorenone, anthraquinone, 4′-methoxyacetophenone, diethoxyacetophenone, biacetyl, 2,3-pentadione, benzyl, 4,4′-methoxybenzil, 4,4′-oxidibenzil, and 2,3-bornadione (dl camphroquinone). Typical tertiary amines include ethyl-4-dimethyl amino benzoate, ethyl-2-dimethyl amino benzoate, 4,4-bis(dimethylamino) benzophenone, n-methyldiethanolamine, and dimethylaminobenzaldehyde.

Another advance in the dental arts is the ability to bleach teeth back to the original white color. This, coupled with society's consciousness of teeth discoloration has resulted in the demand for oral care products and associated procedures for whitening teeth to rapidly increase. There are many methods of treatment relating to the bleaching of teeth. Power bleaching materials contain high concentrations of hydrogen peroxide or other source of active oxygen. Most dental bleaches are applied as gels or pastes which are freshly prepared as needed in the particular dental office. Since hydrogen peroxide is a liquid, a powder is mixed with it for thickening. There may also be other ingredients present, such as catalysts or indicators. Often times, light or heat is part of power bleaching. One of the most frequently used procedures is the application of bleaching agents, such as hydrogen peroxide, and light to whiten discolored teeth.

The combination of photoinitiators and light has rapidly lowered the curing time while increasing bonding strengths of many of the light curing resins. Similarly, the combination of light and oxygen radical generating agents has provided a more effective means for whitening teeth. In view of the use of photoinitiators in dental restorative compositions and the use of light activated bleaching agents, there has been a strong push to improve the light sources that provide the light for curing dental restorative compositions and for the activation of bleaching agents that are applied during teeth whitening procedures.

The light sources currently in use fall into two categories, single point sources and multiple point sources. Single point sources transmit light to a single spot through a single optic while multiple point sources transmit light with multiple transmitting optics. Both systems typically rely on rigid light guides, flexible liquid light guides, and fiber optic bundles to transmit a spot of light at the distal end of the optics. The size of the spot is dependant on the construction of the optic and the active diameter of transmitting optic. Typical light sources include but are not limited to Tungsten Halogen Lamps and derivatives of this technology, Xenon Short Arc Lamps, Metal Halide Lamps, Laser, and LED's.

Light sources used for the purpose of photo initiation of light curing resins and dental tooth whitening fall into two major categories. Light sources such as tungsten halogen, metal halide, and xenon all produce white light that is filtered to transmit only visible light within the general spectral range of 380 520 nanometers. Light sources such as laser and light emitting diode produce visible light which is closely matched to the photo initiators used in light curing resins and activators found in dental tooth whitening formulations.

Light sources such as tungsten halogen, metal halide, and xenon are not very efficient at producing light energy within the spectral range useful for dental photo polymerization and tooth whitening. The energy produced by these light sources in the form of ultraviolet and infrared is not used in the dental application. Light sources such as laser and LED that produce visible blue light with spectral output closely matching the photo initiators used in dental resins and the activators found in dental tooth whitening formulations are much more efficient and produce less heat in the form of infrared wavelengths. Light emitting diodes last for thousands of hours with no degradation in light output eliminating the need to change lamps.

LED light sources have several characteristics which make them desirable as light sources for dental applications. First, the light emitter is small. This allows the proximal end of the dental illumination device to be very close to the emitter and even envelop the source. Secondly, LED's emit very little heat forward (although they do emit heat rearwards). This allows the use of transparent plastics for construction of the dental illumination device as well as single or multiple glass elements. Molded plastics and glass allow for much more complex shapes giving more optical design freedom. Finally, although LED's are efficient, they do not provide as much total light as traditional light sources. This requires that the light guide be very efficient. Current light sources can use less efficient tips because they have surplus power.

Prior use of Light Emitting Diodes for dental light sources relied on multiple LED's placed in arrays to generate enough power to be practical for dental curing. This is expensive and also increases the size of the device. Recent advancements in LED semiconductor technology have resulted in the introduction of a single blue LED that emits radiometric power levels sufficient to allow the rapid photo polymerization of light curing resins and for use in dental tooth whitening. It is recognized that continued advancements in LED semiconductor technology will result in the use of different semiconductor substrate materials to alter the color spectra as well as increase radiometric power for single LED devices.

The domed lens cover used as part of the construction of these mass produced LED's is designed so that light is visible from 360 degrees around the device. This is because the typical application for these devices are indicator lights such as traffic signal lights, automotive brake and signal lights, and signage. The present invention redirects the light energy emitted from the LED and focuses it toward the distal end of the invention in an efficient manner resulting in higher energy levels than possible with a traditional external reflector.

Despite the plethora of light sources, existing technology that provides two arch illumination fails to provide a method or make it easy for the clinician to work on a single tooth. A drawback to these existing full arch light sources that are used to transmit light simultaneously to upper and lower teeth is that they are large, bulky and cumbersome thus requiring a dedicated office. Moreover, these light sources are not easily transportable. These instruments take up floor space and cannot be mounted to the dental chair, wall or counter top. Furthermore, the optic device that transmits the light is not disposable and cannot be easily sterilized.

The full arch light sources are limited to two arch illumination and cannot be used to individually treat discoloration of a single tooth. A further drawback to this equipment is that it is limited to one type of procedure (i.e., exposure of multiple teeth with light). In other words, the equipment does not allow for the exposure of a single spot such as one tooth or one specific area of a tooth. Even though a clinician may only be treating one tooth, the current technologies expose multiple teeth. This is inefficient since a patient's teeth may have varied coloration (e.g., stained) and thus the exposure of all the teeth will not allow the clinician to resolve the single discolored tooth that is being treated.

Today's equipment relies on multiple light transmitting devices such as liquid light guides or fiber optic bundles to focus the light energy around the arches of the teeth. Currently, single point light sources do not allow simultaneous two arch illumination. In contrast to the multiple point sources, the existing single point light sources transmit light to a spot that is roughly the size of a tooth. Thus, the single point light sources cannot be used to treat both arches simultaneously.

U.S. Pat. No. 5,813,854 (“the '854 patent”), attempts to remedy the shortcoming of the existing technologies. The '854 patent discloses a device that utilizes a light diffusion system to direct light to all of the patients tooth. The '854 patent device includes light diffusion means that must be installed in the structure of the device. The light diffusion means are installed in a housing and are used for diffusing light directed into the housing throughout the housing. This complicated system has several drawbacks including the required insertion of diffusion means such as optical gratings (i.e., mirrors) which extend between the upper and lower surfaces of the device. These gratings comprise a complex system of multiple mirrors to reflect light inside the housing to the front of the housing and to the patient's mouth. In addition, the diffusion of light is not efficient because light scatters in directions that are not useful.

A further drawback of the above-mentioned patented device is that it is an elaborate, cumbersome and expensive device. This complex diffusing means requires additional machining and manufacturing protocols which drive the costs of the device higher. It employs a number of components which makes it inherently less reliable than a device that is a simple one component structure.

Published U.S. Patent Application number 20030157456 discloses a device for dental bleaching comprised of a glass core material and cladding intended for simultaneous whitening of upper and lower tooth arches. This device transmits light via an inner glass core and an outer cladding material having a lower refractive index than the core material to retain scattered light within the core material. This device does not make use of an internal reflector, nor does it efficiently harness the light energy of a single LED light source.

Existing technology that provides two arch illumination fails to provide a method of making it easy for a clinician to work on a single tooth. A further drawback to these existing full arch light sources that are used to transmit light simultaneously to upper and lower teeth is that they are expensive, large bulky and not easily transportable. This equipment is also limited in that it is limited to one type of procedure (i.e. exposure of multiple teeth with light). Thus, there is a need for a dental illumination device that can transmit light energy simultaneously across the arches of upper and lower teeth for tooth whitening and photo initiation of light curing resins that is more convenient and less cumbersome to use and that can be used with a single point light source. There is further need for a dental illumination device that can efficiently and effectively use light from a single LED. The present invention addresses these needs. The dental illumination device of the present invention redirects the light energy emitted from the LED and focuses it toward the distal end of the invention in an efficient manner resulting in higher energy levels than possible with a traditional external reflector. The instant invention will work with any combination of single or multiple LED, with dome and without dome, LED emitter with and without dome, single or multiple emitters arrays, and single or multiple die (LED substrate) arrays, of blue or any other color and wavelength single LED, emitter, or die or color arrays of multiple LED, emitter, or die.

### SUMMARY OF THE INVENTION

The present invention provides a dental illumination device that attaches to a LED light source and transmits light energy simultaneously across the arches of upper and lower teeth.

One embodiment of the dental illumination device of the instant invention includes a proximal end, a distal end, and a light directing means. The proximal end is configured for attachment to an LED light source. The distal end is anatomically preformed with a profile complementary to a shape of a dental arch and the light directing means is configured to convey electromagnetic radiation from the proximal end to the distal end.

A further embodiment of the dental illumination device of the instant invention includes a proximal end, a distal end, and at least one light directing means. The proximal end is configured for attachment to an LED light source. The distal end is anatomically preformed with a profile complementary to a shape of a dental arch and the light directing means is a total internal reflector (TIR)configured to convey electromagnetic radiation from the proximal end to the distal end.

Another embodiment of the dental illumination device of the instant invention includes a proximal end, a distal end, and multiple light directing means. The proximal end is configured for attachment to an LED light source. The distal end is anatomically preformed with a profile complementary to a shape of a dental arch and the light directing means are total internal reflectors (TIR)configured to convey electromagnetic radiation from the proximal end to the distal end.

Another embodiment of the present invention relates to a method of whitening at least one tooth in a dental arch. In this method, a whitening solution is applied to at least one tooth. The whitening solution is photoreactive. In this regard, whitening action of the whitening solution is increased in response to absorption of electromagnetic radiation. Additionally, in this method, light is applied to the dental arch utilizing an illumination system. This illumination system includes an LED emitting device and an dental illumination device. The dental illumination device includes a proximal end, a distal end, and a light directing means. The distal end is anatomically preformed with a profile complementary to a shape of a dental arch. The light directing means is configured to convey light from the proximal end to the distal end.

### BRIEF DESCRIPTION OF THE DRAWINGS

FIG. 1 illustrates the inefficiencies of flat ended dental illumination devices.

FIG. 2 illustrates the inefficiencies of dental illumination devices without total internal reflection.

FIG. 3 illustrates the efficiency of a total internal reflector (TIR)

FIG. 4 is a top view of an embodiment of the instant invention.

FIG. 5 is a top view of an additional embodiment of the instant invention.

FIG. 6 illustrates a dental illumination device having multiple TIR.

FIG. 7 illustrates a dental illumination device having multiple TIR.

### DETAILED DESCRIPTION OF THE INVENTION

For simplicity and illustrative purposes, the principles of the present invention are described by referring to various exemplary embodiments thereof. Although the preferred embodiments of the invention are particularly disclosed herein, one of ordinary skill in the art will readily recognize that the same principles are equally applicable to, and can be implicated in other compositions and methods, and that any such variation would be within such modifications that do not part from the scope of the present invention. Before explaining the disclosed embodiments of the present invention in detail, it is to be understood that the invention is not limited in its application to the details of any particular embodiment shown, since of course the invention is capable of other embodiments. The terminology used herein is for the purpose of description and not of limitation. Further, although certain methods are described with reference to certain steps that are presented herein in certain order, in many instances, these steps may be performed in any order as may be appreciated by one skilled in the art, and the methods are not limited to the particular arrangement of steps disclosed herein.

The dental illumination device of the instant invention solves the aforementioned problems associated with transmitting and distributing light energy simultaneously across the arches of upper and lower teeth for dental tooth whitening and photo-initiation of light curing resins while at the same time retaining the benefits of the light source to be used for individual tooth whitening and curing.

The present invention is capable of single or multiple teeth bleaching and curing. Similarly, the present invention allows clinician to treat one or two arches, or single teeth all with the same light source. The instant invention is designed to work with an LED emitter with or without domed lens covers to control beam geometry. The instant invention will work with any combination of single or multiple LED with dome and without dome, LED emitter with and without dome, single or multiple emitters arrays, and single or multiple die (LED substrate) arrays, of blue or any other color and wavelength single LED, emitter, or die or color arrays of multiple LED, emitter, or die.

Most first-generation LED curing devices use flat proximal end tips made from fused glass. A metallic or metal-coated plastic reflector is used to reflect light forward in to the device. The dental illumination device of the instant invention includes at least one total internal reflector (TIR) to direct light from the distal end of the device to the proximal end. Metal reflectors are typically 60-90% efficient compared to acrylic total internal reflection type reflectors which can be over 96% efficient. As such, the dental illumination device of the instant invention more efficiently provides light to the teeth.

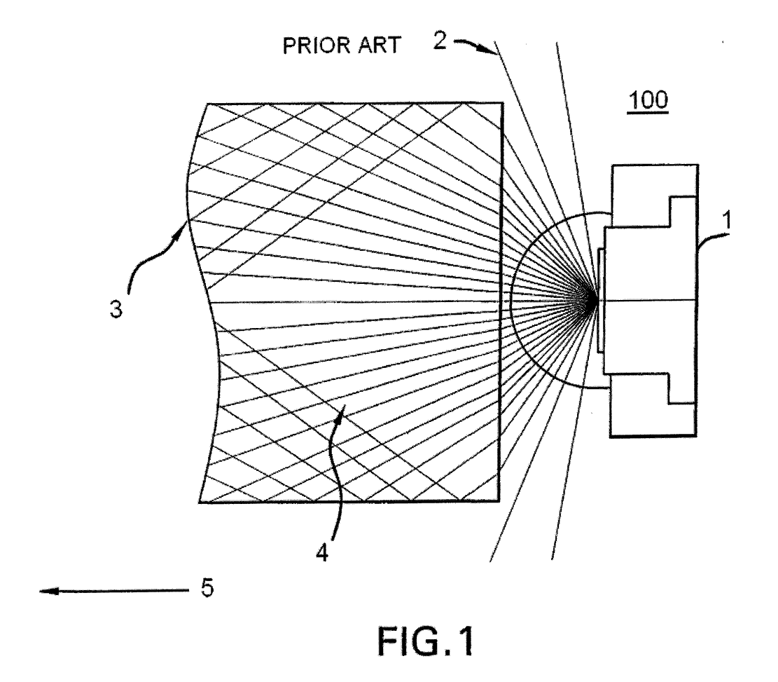

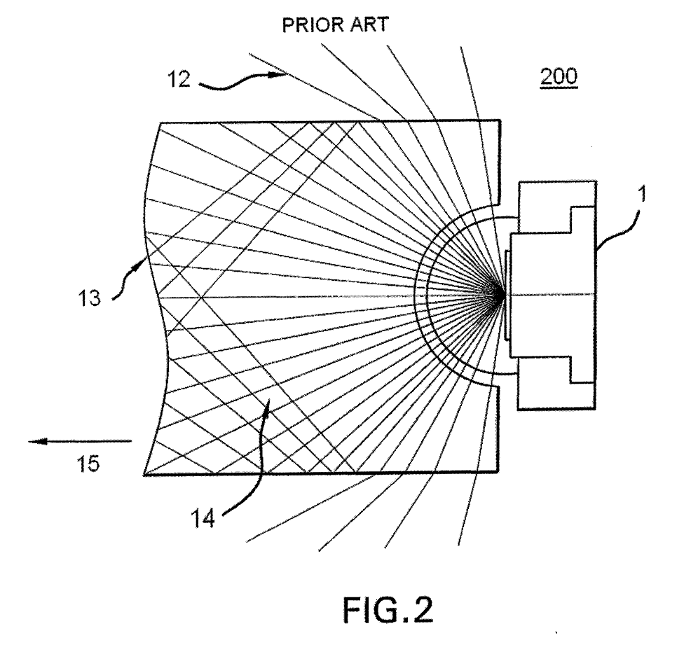

The dental illumination device of the instant invention employs at least one TIR which reduces high angle light and the escape of light. Both high angle light and escaping light make prior art dental illumination devices inefficient. For example, FIG. 1 depicts a prior art device 100 that includes an LED/Emitter 1 and light guide/tip 4. As the figure shows, light guide 4 includes a flat proximal end and straight sides. Light is emitted from LED 1 in all directions. However, due to the flat proximal end, some of the light does not reach light guide 4 but is leaked out the side. This light is shown as lost light 2. Additionally, light that is emitted at a high angle from the center radial of the LED strikes one of the sidewalls of light guide 4 and is reflected towards the other sidewall and disadvantageously is not transmitted towards distal end 5 of the light guide 4. This light is shown as high angle light 3. FIG. 2 depicts another prior art device 200. Device 200 is similar to device 100 except for the proximal end of light guide 14 has been shaped to enclose LED 1. This geometry reduce the amount of lost light that leaks out the side but does not solve the problem of high angle light 13 which is reflected towards the distal end 15 of the light guide. Additionally, light that is emitted at a very high angle from the center line of LED 1 escapes through the outer wall of light guide 14 instead of being internally reflected. This light is shown as escaping light 12.

The reduction in high angle light and escaping light in the dental illumination device of the instant invention is accomplished by providing a TIR which envelopes the LED. TIRs in accordance with this invention preferably comprise an entrance area, the reflector and a lens. These features are preferably molded in to a single part but one of skill in the art would recognize that a TIR may be constructed using any techniques currently used in the art.

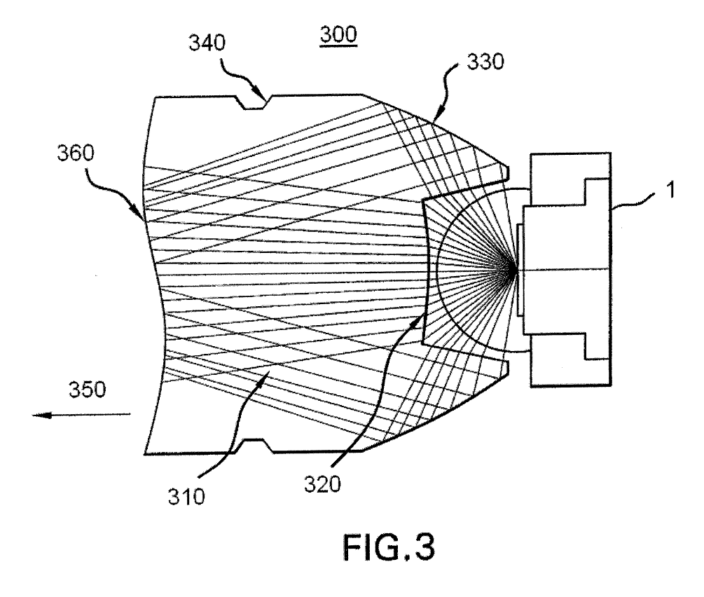

FIG. 3 shows a portion of a light transmitting device 300. The device includes LED 1 and light guide 310. The proximal end of light guide 310 is a specially designed TIR including reflector 300 and lens 320. As the figure shows, the lens 320 is shaped convex to the LED 1 such that light rays emitted from the LED hit the lens and are refracted towards the center of light guide 310 and transmitted towards the distal end 350 of the light guide. Conversely, reflector 330 is shaped concave to the LED 1 such that light rays emitted from the LED hit reflector 330 and are internally reflected towards distal end 350 of the light guide. As the figure shows, this concavity reduces the amount of escaping light and high angle light that was a problem in prior art devices. Low angle light 360 is reflected towards the distal end 350 of the light guide instead of towards the other side of the light guide. The light guide is also shown with groove 340.

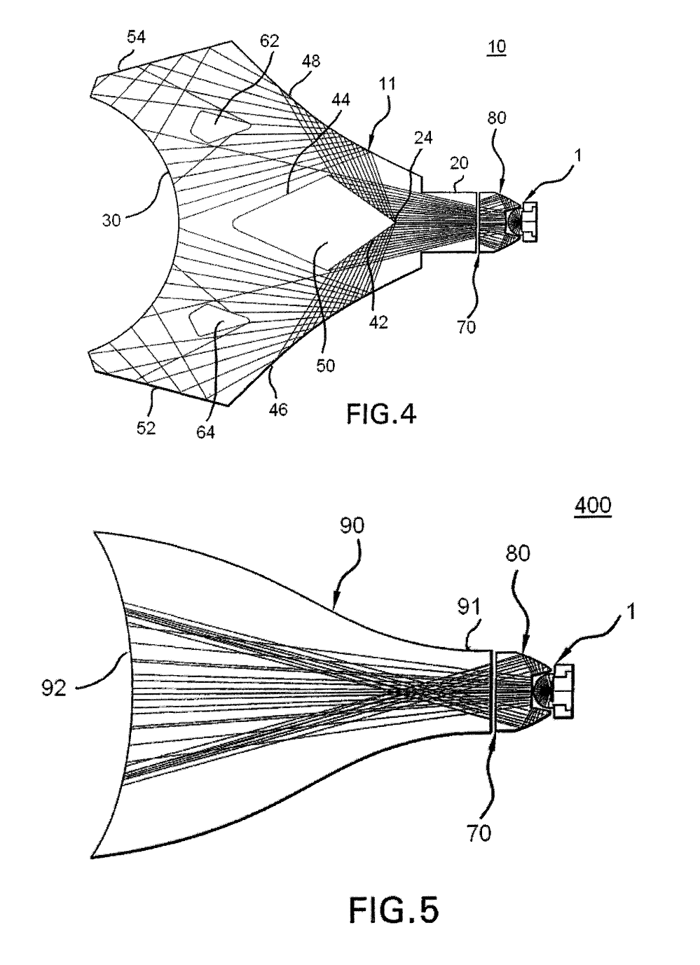

With reference to FIG. 4, there is a dental illumination device of the instant invention particularly adapted to perform a bleaching method and curing method of the instant invention. The dental illumination device allows a standard LED light source to be used for two arch illumination as well as the treatment of individual teeth. The body of dental illumination device may be a simple one-piece article of manufacture. The single piece construction is molded, cast, or machined from a transparent material. Preferably, the construction is molded. The material of the dental illumination device preferably has high transmittance characteristics. Examples of the material include, but are not limited to, acrylic, glass, polycarbonate, and polystyrene. Preferably, the construction is molded acrylic. Furthermore, it is to be understood that the transparency of the material is with respect to the frequency of electromagnetic radiation being transmitted. Generally, the electromagnetic spectrum is defined as being between a frequency range of approximately 10²³ hertz to 0 hertz. However, different dental formulations utilized in dental procedures may be influenced (e.g., polymerized and the like) by a subset of the electromagnetic spectrum. Therefore, it is within the scope of the invention that the materials used to construct device is transparent to a subset of the electromagnetic spectrum. Similarly, the transparency of the material utilized to construct a dental illumination device in accordance with the instant invention may be dependent upon the dental formulation used.

The dimensions of a dental illumination device in accordance with the instant can vary as long as it allows for the clinician to effectively and simultaneously illuminate the upper and lower tooth arches of a dental patient. The device may be configured and dimensioned such that the curvature and height of the device closely matches the arch of the patient's upper and lower teeth. In this regard, the distal end of the device may be anatomically preformed with a profile complementary to a shape of an average dental arch of a statistically pre-determined set of individuals. In addition, other sizes may be used for smaller and larger patient mouths.

In order to achieve the illumination of the patient's teeth, the dental illumination device of the instant invention is attached to an LED light source. The device has a proximal end comprising at least one TIR formed to attach directly to at least one LED light source. The use of this device on an LED light sources shall not preclude or alter the LED light source for other intended purposes. The proximal end of the device can be in any shape that allows for the transmittance of light through device and towards a patient's teeth. This can be achieved simply by changing the size and the diameter of proximal end.

Once the light enters a TIR, the light reflects off the inner walls of the TIR and is directed towards the distal end of the device. This brings light towards the patient's teeth from the sides (right and left), for a more useful light distribution, filling the crevices with light and reducing shadows. Thus, light entering the proximal end is directed in a manner such that it exits the distal end of the device. As such, this system actually directs light to the patient's teeth primarily from the sides as well as from several other (secondary) directions as opposed to a diffusion system.

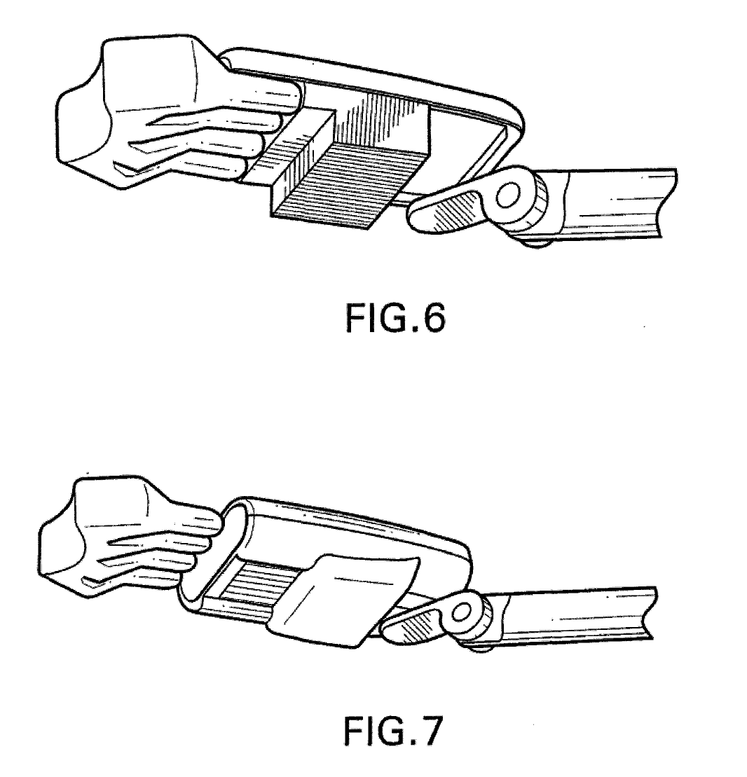

The dental illumination device of the present invention generally includes an LED and a light transmitting device. The light transmitting device generally includes a proximal end and a distal end. The proximal end receives light from the LED and is preferable a specially designed TIR. The distal end transmits light to a patients teeth and is preferably shaped to correspond to a patient's dental arch. FIGS. 5 and 6 show different embodiments of the light transmitting device of the instant invention.

One embodiment of device as seen in FIG. 4, comprises a set of cores that are strategically placed in front of proximal end such that the incoming light is reflected toward the left or right hand side of device. The angles of the cores are about 45°. At this particular angle, the light reflects from inner walls rather than going through the walls of device. If the angle is greater than about 47° from the center line, the light will pass through inner walls. Thus, if the angle is less than about 47°, the light will reflect off of inner walls towards the front of device.

FIG. 5 shows dental illumination device 10. Device 10 includes LED 1 and TIR 80. TIR 80 is substantially the same shape as the proximal end of light guide 310 of device 300 shown in FIG. 3. TIR 80 receives light from LED 1 and transmits it into the proximal end 20 of “Crystal” Bleaching Mouthpiece 11. Mouthpiece 11 includes core 50 which is placed towards the proximal end of the mouthpiece in order to direct or split the light transmitted by TIR 80 to alternate sidewalls of mouthpiece 11. Core 50 includes left inner walls 42, right inner wall 44 and corner 24. Corner 24 is preferably set at an angle of about 45° such that the light reflects off of inner walls 42, 44 instead of passing the walls and transmitting through core 50. Light reflecting off of inner wall 42 is directed towards mouthpiece outer wall 46. Light reflecting off of inner wall 44 is directed towards mouthpiece outer wall 48. Both walls 46 and 48 are shaped convex to LED 1 such that the light is reflected towards distal end 30 of the mouthpiece. As shown, mouthpiece 11 preferably also contains cores 62 and 64 on either side of the mouthpiece and distal to core 50. Cores 62, 64 direct light towards either further outer walls 52, 54 of the mouthpiece or towards distal end 30 of the mouthpiece. Further outer walls 52, 54 are preferably straight side walls angled inwards towards distal end 30 of mouthpiece 11. As show, distal end 30 is preferably shaped to correspond to the patient's dental arch. The figure also shows that at the joint 70 between TIR 80 and mouthpiece 11 there can be an air gap, a cement filled gap or no gap. Preferably, mouthpiece 11 is a single piece molded construction.

FIG. 5 shows an alternative embodiment of the dental illumination device of the present invention. Device 400 has an identical proximal end as device 10 including LED 1 and TIR 80. Device 400 further includes fiber optic device 90. Fiber optic device 90 is preferably shaped flared outward from proximal end 91 to distal end 92. Distal end 92 is preferably shaped to correspond to a patient's dental arch. Fiber optic device 90 is preferably formed from glass with cladding. As in device 10, joint 70 can be an air gap, a cement filled gap or no gap. One example of a fiber optic device is disclosed in U.S. Published Patent Application No. 2003/0157456, credited to Plocharczyk.

With reference to FIG. 4 and 5, there is shown a “ray trace.” This “ray trace” demonstrates the pathway of light from a light source through an embodiment of device. Particularly, it shows the origination of the light from a light source being reflected forward through a TIR, and proceeding through the respective devices towards their distal ends Note that the vast majority of the light will proceed to the distal end of device and project onto the patient's teeth from several directions. It is recognized that not all of the light will follow the aforementioned path. For example, some light may proceed directly from light source through the device, proceed to the distal end of device and project onto the patients teeth.

Although only bleaching mouthpiece 11 and fiber optic device 90 are shown connected to TIR 80, the invention is not so limited. As described above, the present invention provides a dental illumination device that can be used to illuminate light on an entire dental arch or a single tooth. In one embodiment of the invention, a traditional light guide can be attached to TIR 80 such that light may be transmitted to a single tooth or portion of a tooth. This light guide may be interchanged with a device such as mouthpiece 11 or fiber optic device 90 such that a single dental illumination device can be used for simultaneously transmitting light across the arches of upper and lower teeth or for transmitting light to a single tooth or a portion of a tooth.

FIGS. 6 and 7 show three dimensional depictions of a light transmission device of one embodiment of the present invention. FIG. 6 shows the device plugged into a device holder. FIG. 7 shows the device unplugged.

While the invention has been described with reference to certain exemplary embodiments thereof, those skilled in the art may make various modifications to the described embodiments of the invention without departing from the scope of the invention. The terms and descriptions used herein are set forth by way of illustration only and are not meant as limitations. In particular, although the present invention has been described by way of examples, a variety of compositions and methods would practice the inventive concepts described herein. Although the invention has been described and disclosed in various terms and certain embodiments, the scope of the invention is not intended to be, nor should it be deemed to be, limited thereby and such other modifications or embodiments as may be suggested by the teachings herein are particularly reserved, especially as they fall within the breadth and scope of the claims here appended. Those skilled in the art will recognize that these and other variations are possible within the scope of the invention as defined in the following claims and their equivalents.

What is claimed:

1. A dental illumination device comprising:
a proximal end configured for attachment to at least one LED light source;
a distal end anatomically preformed with a profile complementary to a shape of a dental arch; and
at least one light reflecting means configured to convey light from said proximal end to said distal end wherein said at least one light reflecting means comprises:
a reflecting means; and
a refracting means;
wherein the reflecting means is concave to the light source and reflects light from the light source towards the distal end o the dental illumination device, and wherein the refracting means is convex to the light source and refracts light from the light source towards the distal end of the dental illumination device, and wherein the reflecting means and the refracting means are constructed of a single continuous homogeneous material.

2. The dental illumination device according to claim 1, wherein said LED light source is positioned within said proximal end.

3. The dental illumination device according to claim 1, wherein the at least one light reflecting means is a total internal reflector.

4. The dental illumination device according to claim 1, wherein the proximal end is configured to attach to multiple LED light sources.

5. The dental illumination device according to claim 1, wherein the device comprises multiple total internal reflectors.

6. The dental illumination according to claim 1, constructed from at least one of acrylic, glass, polycarbonate, and polystyrene.

7. The dental illumination according to claim 1, further comprising a core, a left side, and a right side, said core having a first angle of approximately 45°, wherein said core is configured to substantially reflect electromagnetic radiation toward said left side and said right side.

8. A system to transmit light to a dental arch, said system comprising:
at least one LED light source; and
a dental illumination device comprising:
a proximal end configured for attachment to said at least one LED light source;
a distal end anatomically preformed with a profile complementary to a shape of a dental arch; and
a light directing means, wherein said light directing means is configured to convey electromagnetic radiation from said proximal end to said distal end, and wherein said light directing means comprises:
a reflecting means; and
a refracting means;
wherein the reflecting means is concave to the light source and reflects light from the light source towards the distal end of the dental illumination device, and wherein the refracting means is convex to the light source and refracts light from the light source towards the distal end of the dental illumination device, and wherein the reflecting means and the refracting means are constructed of a single continuous homogeneous material.

9. The system according to claim 8, wherein said at least one LED light source is positioned within said proximal end.

10. The system according to claim 8, wherein the light reflecting means is a total internal reflector.

11. The system according to claim 8, wherein the dental illumination device comprises multiple total internal reflectors.

12. The system according to claim 8, wherein the proximal end of the dental illumination device is configured to attach to multiple LED light sources.

13. The system according to claim 10, wherein said dental illumination device is constructed from at least one of acrylic, glass, polycarbonate, and polystyrene.

14. The system according to claim 8, wherein said dental illumination device comprises a core, a left side, and a right side, said core having a first angle of approximately 45°, wherein said core is configured to reflect electromagnetic radiation toward said left side and said right side.

15. A method of whitening at least one tooth in a dental arch comprising:
applying a whitening solution to at least one tooth, said whitening solution is photoreactive, wherein whitening action of said whitening solution is increased in response to absorption of light; and
applying light to said dental arch utilizing an illumination system comprising:
at least one LED light source; and
a dental illumination device comprising:
a proximal end configured for attachment to at least one LED light source;
a distal end anatomically preformed with a profile complementary to a shape of a dental arch; and
at least one light directing means configured to convey light from said proximal end to said distal end, wherein said at least one light directing means comprises:
a reflecting means; and
a refracting means;
wherein the reflecting means is concave to the light source and reflects light from the light source towards the distal end of the dental illumination device, and wherein the refracting means is convex to the light source and refracts light from the light source towards the distal end of the dental illumination device, and wherein the reflecting means and the refracting means are constructed of a single continuous homogeneous material.

16. The method according to claim 15, wherein light is applied utilizing said illumination system having said at least one LED light source positioned within said proximal end.

17. The method according to claim 15, wherein the light directing means is a total internal reflector.

18. The method according to claim 15, wherein the dental illumination device comprises multiple total internal reflectors.

19. The method according to claim 15, wherein the illumination system comprises multiple LED light sources.

20. The method according to claim 15, wherein the dental illumination device is constructed from at least one of acrylic, glass, polycarbonate, and polystyrene.

21. The method according to claim 15, wherein the dental illumination device comprises a core, a left side, and a right side, said core having a first angle of approximately 45°, wherein said core is configured to reflect electromagnetic radiation toward said left side and said right side.

22. A method of curing a photo-reactive compound in a dental arch comprising:
applying a photo-reactive compound to at least one tooth; and
applying light to said dental arch utilizing an illumination system comprising:
an LED light source; and
a dental illumination device comprising:
a proximal end configured for attachment to said LED light source;
a distal end anatomically preformed with a profile complementary to a shape of a dental arch; and
a light directing means configured to convey light from said proximal end to said distal end, wherein said light directing means comprises:
a reflecting means; and
a refracting means;
wherein the reflecting means is concave to the light source and reflects light from the light source towards the distal end of the dental illumination device, and wherein the refracting means is convex to the light source and refracts light from the light source towards the distal end of the dental illumination device, and wherein the reflecting means and the refracting means are constructed of a single continuous homogeneous material.

23. The method according to claim 22, wherein light is applied utilizing said illumination system having said LED light source is positioned within said proximal end.

24. The method according to claim 22, wherein the light directing means is a total internal reflector.

25. The method according to claim 22, wherein the dental illumination device is constructed from at least one of acrylic, glass, polycarbonate, and polystyrene.

26. The method according to claim 22, wherein the dental illumination device comprises a core, a left side, and a right side, said core having a first angle of approximately 45°, wherein said core is configured to reflect electromagnetic radiation toward said left side and said right side.

27. A dental illumination device of single piece construction comprising:
a proximal end configured for attachment to a light source;
an arch shaped distal end;
at least one core;
a left side; and
a right side,
wherein the proximal end comprises a reflecting means and a refracting means and wherein the at least one core is configured to receive light from the proximal end and reflect it towards the left side and the right side.

28. The dental illumination device according to claim 27, wherein the distal end is anatomically preformed with a profile complementary to a shape of a dental arch.

31. The dental illumination device according to claim 27, wherein the dental illumination device is constructed from at least one of the materials selected from the group consisting of: acrylic, glass, polycarbonate, and polystyrene.

32. A dental illumination device comprising:
a light source;
a proximal end configured to receive light from the light source;
a first total internal reflection means;
a second total internal reflection means; and
a distal end anatomically preformed with a profile complementary to a shape of a dental arch, wherein the first total internal reflection means is configured to cause the light transmitted from the light source to undergo a first internal reflection and direct the first internally reflected light towards the second total internal reflection means, and wherein the second total internal reflection means is configured to cause the light transmitted from the light source to undergo a second internal reflection and direct the second internally reflected light towards the distal end of the dental illumination device, and wherein the first total internal reflection means and the second total internal reflection means are not constructed of a single homogeneous material.

33. The device of claim 32 wherein the first total internal reflection means comprises:
a reflecting means; and
a refracting means;
wherein the reflecting means is concave to the light source and reflects light from the light source towards the distal end of the dental illumination device, and wherein the refracting means is convex to the light source and refracts light from the light source towards the distal end of the dental illumination device, and wherein the reflecting means and the refracting means are constructed of a single continuous homogeneous material.

34. The device of claim 32 wherein the second total internal reflection means comprises:
a core;
a left side;
a right side; and
an axis of rotation;
wherein said core comprises a first angle of approximately 45° with respect to the axis of rotation, and wherein said core is configured to reflect light toward said left side and said right side.

35. The device of claim 32 wherein said light source is positioned within said proximal end.

36. The device of claim 32 wherein the light source comprises at least one LED.
